(19) United States
(12) Patent Application Publication
(10) Pub. No.: US 2002/0141453 A1
(43) Pub. Date: Oct. 3, 2002

(54) Flexible add-drop multiplexer for optical telecommunication networks

(76) Inventor: Nasir Ghani, La Jolla, CA (US)

Correspondence Address: BROBECK, PHLEGER & HARRISON LLP, 12390 EL CAMINO REAL, SAN DIEGO, CA, 92130, US

(21) Appl. No.: 09/825,591

(22) Filed: Apr. 3, 2001

(51) Int. Cl. H04J 3/04

(52) U.S. Cl. 370/535; 370/537

(57) ABSTRACT

An add-drop multiplexer in a dense wavelength division multiplexing optical transmission system has one spatial switch between laser outputs and a fiber link transmit interface, and a second spatial switch between its receivers and a fiber link receive interface. The spatial switches allow the associations between received and transmitted data channels and the multiple wavelengths of the dense wavelengths division multiplexing system to be varied dynamically.

### BACKGROUND OF THE INVENTION

1. Field of the Invention

The present invention relates to optical transmission systems and, more particularly, to add-drop multiplexers used in optical wavelength division multiplexing networks.

2. Background

In optical transmission systems, data is converted into light impulses by modulating emitters at an ingress port, sent through a transmission medium, and received and demodulated at an egress port. The transmission medium is generally optical fiber, used because of its many advantages, including cost, low signal attenuation, high data throughput capacity, and relative insensitivity to electromagnetic interference. “Optical” and “light” in this context are not limited to visible part of the electromagnetic spectrum, but cover part of the spectrum located between X-ray and microwave wavelengths. Broadly, optical part of the spectrum is considered to cover wavelengths between 10 nanometers and 1 millimeter. Two of the bands now commonly used in optical networks are 1310 nanometers and 1550 nanometers, both in the infrared region.

At the time of this writing, optical networks can transmit data on a single wavelength at speeds up to 10 Gbits per second (signal rate OC-192), and 40 Gbit/s (OC-768) systems are in the works. The theoretical limit of a single wavelength's bandwidth is much higher, and a fiber can typically support many discrete wavelengths.

Multiplication of telecommunication services and expanding bandwidth requirements of the services exert continuing pressure on existing telecommunications networks to increase their data carrying capacity. Techniques for increasing the data carrying capacity of fiber include frequency division multiplexing, and wavelength division multiplexing (“WDM”), often referred to as dense wavelength division multiplexing (“DWDM”) when a relatively high number of wavelengths are multiplexed.

Frequency division multiplexing increases the data carried by one wavelength. To date, this technology has not been widely commercialized.

DWDM multiplexes data onto multiple, independent optical data streams or channels on a single fiber. Each of the channels is carried by a different and distinct wavelength of light, typically emitted by a wavelength-specific laser modulated by a data signal. The number of channels per fiber can be as high as 128, and will likely continue to increase. DWDM technology is now widely used, especially in long-haul networks.

(In the preceding paragraph and throughout this document, wavelength-specific or fixed-wavelength means not dynamically reconfigurable in real time.)

One type of general architecture used in DWDM systems is wavelength routing. In a wavelength routed network, the path of each data stream through the network is determined by the stream's wavelength, the ingress port, and the setup of the network's routing elements, e.g., routers, switches, and wavelength converters.

A single wavelength may be associated with a data stream as it travels through the various nodes of the network. This is the wavelength path routing technique. The data stream may also be routed without a permanent association with a single wavelength. Instead, the wavelength carrying the data stream may be reassigned at optical cross connect (“OXC”) nodes as the data stream travels from one span of the network to another. This is the virtual wavelength path routing technique.

A DWDM network, e.g., a SONET ring, will likely have more than two nodes. At some points along a fiber, additional nodes may need to add and/or remove (“drop” or divert) data stream(s) to and from the main signal path of the fiber. The added and dropped data streams may be locally generated. They may also come from other connections. (Network architecture may thus differ for various wavelengths; for example, it may be configured as a ring for wavelength λ₁, and provisioned as a point-to-point connection for λ₂.) Adding and dropping data streams is the function performed by add-drop multiplexers (“ADMs”).

Optical add-drop multiplexer (“O-ADM”) nodes are the optical network elements that integrate access and transport functions of optical networks. These devices add, drop, or pass-through selected wavelength channels in order to extend optical transparency over multiple fiber spans, a function that is gaining importance with increasing complexities of optical networks.

The emergence of wavelength routing network devices—optical cross connects and add-drop multiplexers—makes it in theory possible for “edge” client devices (i.e., network boundary access devices) to connect seamlessly to each other, thereby extending virtual network spans over great distances. To realize fully this theoretical possibility in practice, flexible optical access solutions are needed.

Presently available transparent O-ADM node designs do not yield full flexibility, since client-wavelength associations are fixed by physical port assignments. (By “transparent” I mean a single wavelength channel that is not transported as a payload of another layer data stream, such as SONET/SDH.) For example, suppose a data stream needs to be transported between nodes A and B. Suppose further that the data stream is associated with wavelength λ₁ at node A because of the physical port assignment of the data stream on that node; in other words, the transmitter/modulator at node A of the port that receives the data stream is a wavelength-specific transmitter tuned to A₁. If A₁ is not available on the span between A and B (possibly because another channel is using A₁), then the connection for the data stream will be denied or rerouted, even if another wavelength λ₂ is available between nodes A and B. The same problem arises if the receiver available at node B is not tuned to λ₁. This simple example illustrates the problem caused by fixed client-wavelengths associations.

Many O-ADM ring schemes are two- or four-fiber ring schemes, with different fibers carrying counter-propagating data flows. These schemes have evolved from electronic SONET/SDH ring schemes and are capable of replicating fast protection switching functionality in the optical domain. In contrast, most current O-ADM designs are based on opto-electronic (O-E) conversion. These schemes are not very scalable because they require high-speed electronic circuitry for each terminated and originated wavelength channel. Furthermore, opto-electronic schemes usually rely on fixed data format/rate tributary signals (e.g., SONET/SDH, digital wrappers). Such solutions are therefore not transparent. As a result, most opto-electronic transport schemes require all client signals to be mapped into some payload format, and hence scale poorly and are not well suited to accommodating continually emerging newer, faster transmission formats.

Transparent optical O-ADM designs have also been proposed. FIG. 1 illustrates an example of a basic two-fiber ring O-ADM node 100 for DWDM networks. (A similar configuration can also be drawn for four-fiber ring O-ADM design.) The data streams flow in opposite directions on the two fibers 105 and 110. The data stream of fiber 105 is received through fiber link Rx interface 115 and transmitted by fiber link Tx interface 120. Similarly, fiber link Rx and Tx interfaces 125 and 130 receive and transmit data streams of fiber 110, respectively. A bank of wide-band receivers 135 performs opto-electronic conversion of the received signals for possible routing of each signal to an electronic client through an associated set of ITU-T interfaces 140. (ITU-T refers to standards propounded by the Telecommunications Standardization Sector of International Telecommunication Union, a standard-setting organization based in Geneva, Switzerland.) A second set of ITU-T interfaces 145 receives client signals and drives a bank of transponders 150. (The concept of transponder in this document is includes transmitters and modulators.) I mean either Each of the transponders can receive an optical data channel from an ITU-T interface and convert it to a different, fixed-wavelength channel for transmission over the network. The two fibers are coupled to wide band receivers 135 through sets of 2×1 switches 155 and 160, as shown; in the same fashion, transponders 150 are coupled to the fibers through sets of 2×1 switches 165 and 170. (The use of 2×1 switches in FIG. 1 and other figures of this document is purely exemplary; other switch configurations may be used.)

Each set of switches has 2W 2×1 switches. As should be clear from FIG. 1 to those of ordinary skill in the art, the “2W” quantity signifies two times the number of discrete wavelength channels on each of the fibers. We assume here that each fiber has the same number W of such channels. More generally, if fiber 105 has W₁ channels and fiber 110 has W₂ channels, then the maximum number of required switches for both receive and transmit sides would be 2(W₁ +W₂).

With design configuration of FIG. 1, the network operator must ensure that the ingress and egress optical ring nodes connect to the client devices at the correct pre-determined wavelength values. This “static” setup severely restricts the network wavelength routing algorithms, and therefore results in inherently increased ring channel blocking probabilities. As described above, even if a lightpath channel is available from an ingress optical ring node to an egress optical ring node, it may not be possible for the O-ADM device to use the channel because of discontinuity with the client port's wavelength association determined by the specific receiver and laser connected to the client. Many advanced higher-layer traffic engineering applications, such as those using multi-protocol label switching (“MPLS”), need the capability to open and/or close connections between multiple edge client routers dynamically. Hence, any O-ADM setup that requires peer routers to be on the same wavelength channel will be restrictive, causing increased connection blocking and re-routing inefficiencies.

A limited, stop-gap solution here is to connect some of the ports on a client device (e.g., a router, an ATM switch, a SONET/SDH multiplexer) to multiple O-ADM ports, or even to all O-ADM ports. Although multiple port connections may improve the blocking probabilities, this solution has at least two major drawbacks. First, unless each client port is connected to each of the wavelengths, wavelength selection is still restricted. Second, client devices must purchase multiple connection ports, increasing bandwidth costs and reducing resource utilization for network service providers.

As the number of parallel fibers and the number of wavelength channels per fiber grow, the drawbacks of this multi-connection solution become more and more limiting.

Another approach is to use tunable transmitters and receivers. In other words, routing flexibility can be improved by replacing fixed-wavelength lasers in transponders 150 and filters in receivers 135 of FIG. 1, with tunable variants of such components. These approach requires very careful component calibration to prevent frequency drift, and presents much higher component and maintenance costs. Moreover, tunable lasers have not yet evolved sufficiently to gain broad acceptance and apparently are not widely available in the current marketplace.

What is needed, therefore, is O-ADM node design that scales well and allows dynamic selection of the wavelength at which a client signal is inserted into and extracted from the network.

### SUMMARY OF THE INVENTION

The present invention is an optical system for switching physical channels, such as wavelength channels, in an optical communication network. The switching system may be an add-drop multiplexer, an add only multiplexer, or a drop only multiplexer. The switching system may provide a switching fabric interposed between channel inputs and a transponder block of the system, a switching fabric interposed between channel receivers and link receive side (e.g., an optical link receive interface or a bank of switches connected to an optical link receive interface), or both switching fabrics. The optical switching system my further provide a bypass connection allowing some of the channels to bypass the multiplexer.

### BRIEF DESCRIPTION OF THE DRAWINGS

The present invention will be described with particular embodiments thereof, and references will be made to the drawings in which:

FIG. 1, described above, illustrates an example of a basic two-fiber optical add-drop multiplexer node in a DWDM network.

FIG. 2 illustrates a flexible two-fiber add-drop multiplexer with transmit and receive optical switch fabrics.

FIG. 3 illustrates a single fiber optical add-drop multiplexer with transmit and receive optical switch fabrics.

FIG. 4 illustrates a two-fiber optical add-drop multiplexer with bypasses for selected channels on each of the fibers.

FIG. 5. illustrates an optical add-drop multiplexer with transmit and receive optical switch fabrics switching to a reverse-direction (backup) path after a primary path fault.

FIG. 6 illustrates wavelength conversion in an intermediate node with an add-drop multiplexer having transmit and receive optical switch fabrics.

### DETAILED DESCRIPTION

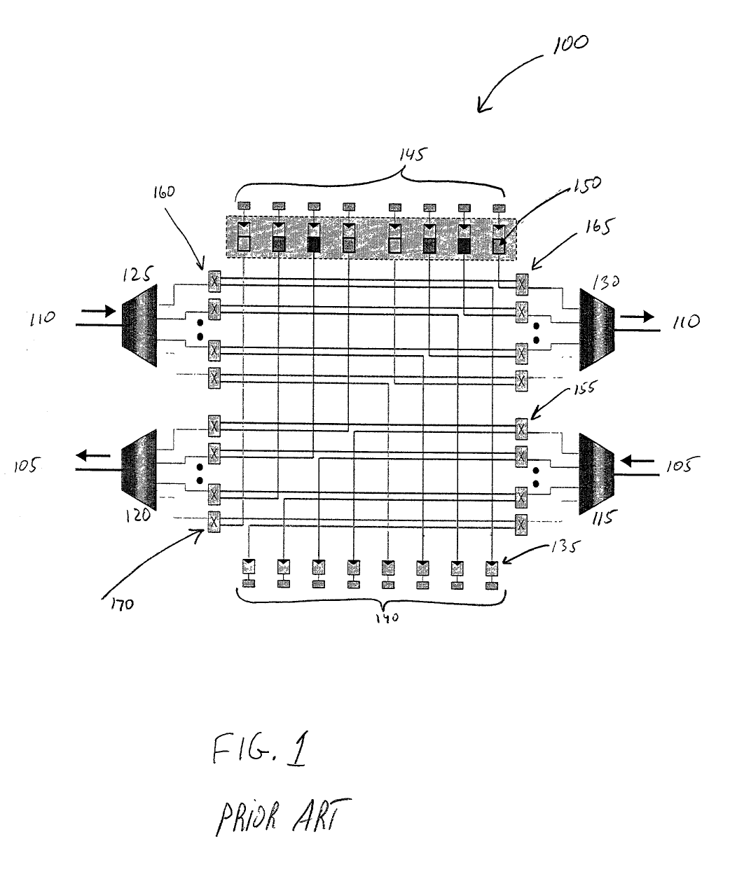

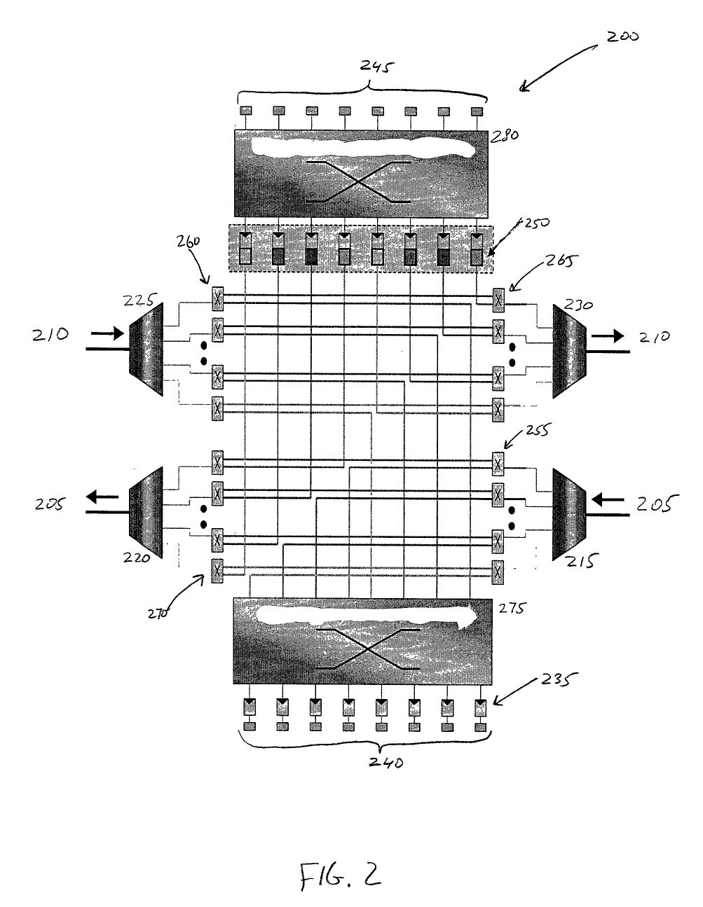

FIG. 2 shows an add-drop multiplexer 200 in a two-fiber ring network. As in FIG. 1, two data streams—two sets of wavelengths or channels—flow in opposite directions on a pair of fiber-optic cables 205 and 210. Fiber link Rx interfaces 215 and 225 receive their respective data streams and route them through sets of 2×1 switches 255 and 260, respectively, to a bank of wide-band receivers 235. Receivers 235 perform conversion of the received signals from an optical to an electronic format and route them to the clients through an associated set of interfaces 240. Interfaces 240 may, but need not, be ITU-T interfaces.

Unlike the multiplexer of FIG. 1, the wide-band receivers are not directly coupled to the 2×1 switches of the fiber link Rx interfaces. Instead, receive optical switch fabric 275 is interposed between receive side switches 255/260 and wide-band receivers 235. In general, optical switch fabric 275 may be capable of switching each of the channels received from 2×1 switches 255/260 to any receiver of receiver bank 235. Optical switch fabric 275 may be more limited, with capability to switch fewer than all channels to fewer than all receivers.

Similarly, transmit optical switch fabric 280 is interposed between interfaces 245 and transponders 250, so that a signal input into each of the interfaces 245 can be routed to any of the fixed-wavelength transponders 250. Outputs of the transponders connect to fiber link Tx interfaces 220 and 230 through banks of switches 265 and 270. As in the case of the receive side, interfaces 245 may, but need not, be ITU-T interfaces; and the transmit optical switch fabric may have more limited switching capability.

A computer (not illustrated) controls the switches and the optical switch fabrics of add-drop multiplexer 200 to determine which of the channels are added, which are dropped, and which pass through the multiplexer. The computer may be a special purpose computer or a general purpose computer under control of routing software.

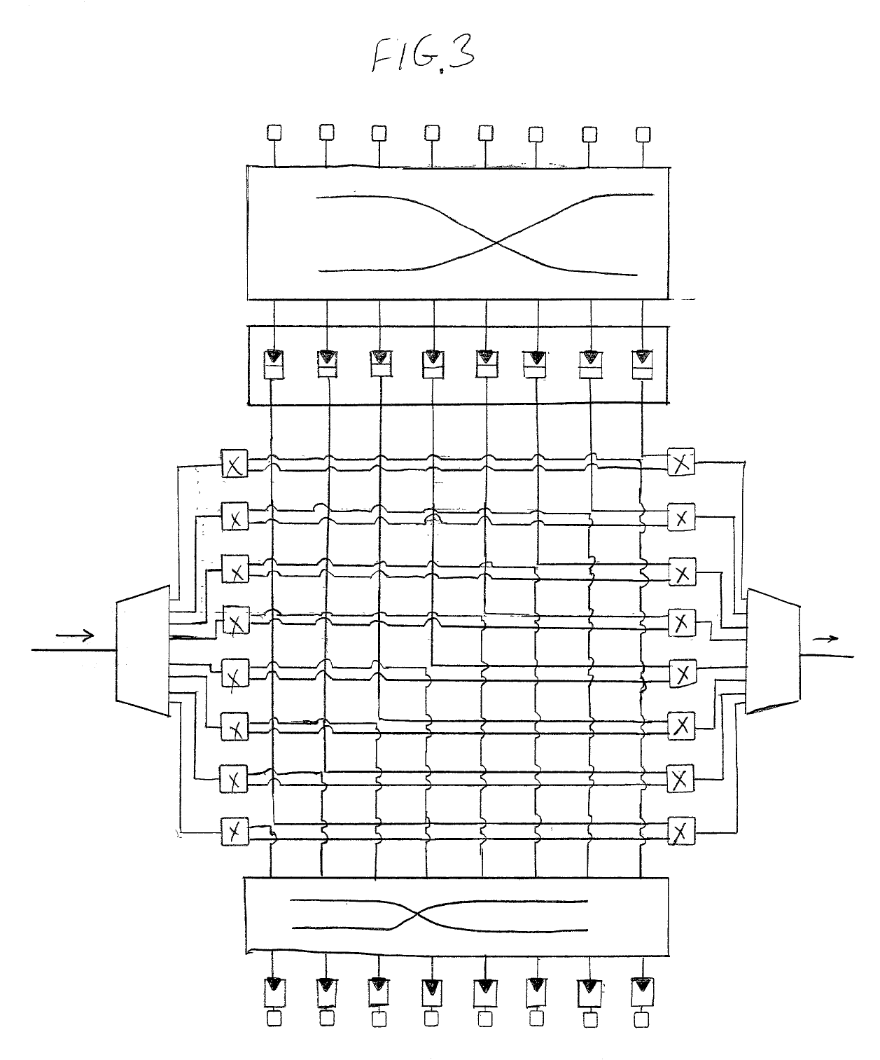

Note that the configuration of FIG. 2 can be easily extended to a four-fiber ring O-ADM design. In fact the configuration will work with any number of fibers, including the rare case of a single-fiber network. A single-fiber O-ADM is illustrated in FIG. 3. It is essentially one-half of the O-ADM of FIG. 2.

The size of the matrices in receive and transmit optical switching fabrics of a ring network is generally much smaller than that required in larger, multi-fiber OXC-type devices. Specifically, because wavelength channels are often limited to those propagating along 2- or 4- fiber rings, the matrices are bounded by 2W×2W and 4W×4W sizes, respectively, with W denoting the number of wavelengths per fiber, as before.

In many applications, only a subset of wavelength channels may need to be sourced or sinked at a particular O-ADM node to achieve sufficient wavelength routing flexibility. In these applications there is no need for full-spectrum multiplexing or demultiplexing and ensuing per-wavelength processing described in connection with the O-ADM of FIG. 2. To reduce hardware complexity and cost, some subset of N channels of the total number of channels can be selected for routing to all or a subset of receivers or transmitters of an O-ADM node. This will reduce the size of the switching matrices. Moreover, either of the optical switching fabrics 275 and 280 (of FIG. 2) may be eliminated, resulting in an O-ADM node capable of flexible routing on either the receive or the transmit side, but not both. This may be a cost effective solution where, for example, channel requirements are relatively constant in one direction.

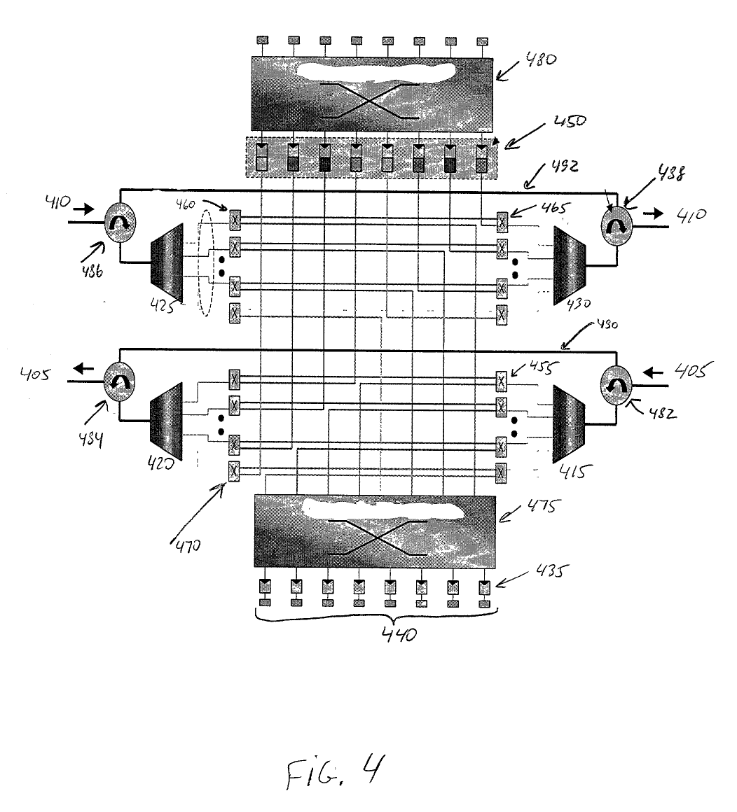

Taking this matrix reduction approach in a slightly different direction, coarse (i.e., wide-band) filters may be used to add and/or drop selected sub-groups of wavelength channels. This second design is illustrated in FIG. 4 for a two-fiber ring DWDM multiplexer. In this figure, all the elements familiar from FIG. 2 appear in substantially the same relationship to each other, and perform substantially the same functions, including:

1. Optical fibers 405 and 410;

2. Fiber link Rx interfaces 415 and 425;

3. Sets of 2×1 switches 455 and 460 on the receive side;

4. A bank of wide-band receivers 435;

5. ITU-T receive interfaces 440;

6. Receive optical switch fabric 475; 7. Fiber link Tx interfaces 420 and 430;

8. Sets of 2×1 switches 465 and 470 on the transmit side;

9. Transponders 450;

10. Transmit optical switch fabric 480; and

11. ITU-T transmit interfaces 445.

In addition, the add-drop multiplexer of FIG. 4 has optical signal splitter 482 at the input to fiber link Rx interface 415, optical signal combiner 484 at the output of fiber link transmit interface 420, optical signal splitter 486 at the input to fiber link Rx interface 425, optical signal combiner 488 at the output of fiber link transmit interface 430, and a pair of mux bypass connections 490 and 492. Mux bypass connection 490 between splitter 482 and combiner 484 transparently passes through the multiplexer a subset of N₁ wavelength channels (of the W₁ total wavelengths channels of fiber 405) with small signal losses. In the same fashion, mux bypass connection 492, splitter 486, and combiner 488 bypass a subset of N₂ wavelength channels of the W₂ channels of fiber 410.

As before, the number of the channels carried by each fiber need not be the same, and the number of fibers can vary. One or more of the fibers may be bypassed, while other fiber or fibers may be connected as in FIG. 2. The size of the subsets of bypassed channels can also vary from fiber to fiber.

The optical splitters and combiners appear as circulators in FIG. 4. Circulators, based on Faraday effect, are non-reciprocal devices that direct light from port to port in one direction only. They are useful in combination with filters to minimize losses of the pass-through signals. But different devices can be used for bypassing, including, for example, simple power splitter/combiner pairs in combination with filters, comb filters, and interleavers.

The size of the switching fabric in the multiplexer of FIG. 4 is thus decreased in comparison with the size of the multiplexer of FIG. 2, because fewer channels need to be switched by the fabric. Moreover, fewer optical switches are needed because the bypassed channels do not require them, producing additional cost savings.

From the above discussion of the embodiments of the inventive O-ADMs, it should be clear that no specific type of switching fabric is required, as long as the switching fabric is capable of switching laser inputs from the client side and WDM laser inputs from the network side. For example, digital electronic switching can be used, where the optical signals are first converted into electronic form, and then switched electronically. But at present time, optical spatial switching appears to be best suited to the task because of its high-bandwidth throughput and, as is implied by the “spatial” moniker, the ability to switch any input wavelength channel to any output. Considering the rapidly-declining cost of optical micro-electromechanical systems-based (“MEMS-based”) switching fabrics and continuing improvements in their miniaturization and packaging, optical spatial switching may retain its advantages for some time.

Spatial switching improves optical lightpath blocking probabilities because it allows wavelength selection flexibility, and hence wavelength utilization, in both client signal insertion and extraction nodes. Client device (e.g., router) connectivity increases and, along with it, the effectiveness of higher-layer traffic engineering applications. The penalties associated with the use of spatial switching cost and size—appear to be decreasing, especially considering the improvements being made in MEMS-based switching fabrics. Overall, for many network operators the resulting increased level of flexibility and resource utilization will more than offset any additional costs potentially imposed by the use of switching fabrics in O-ADMs.

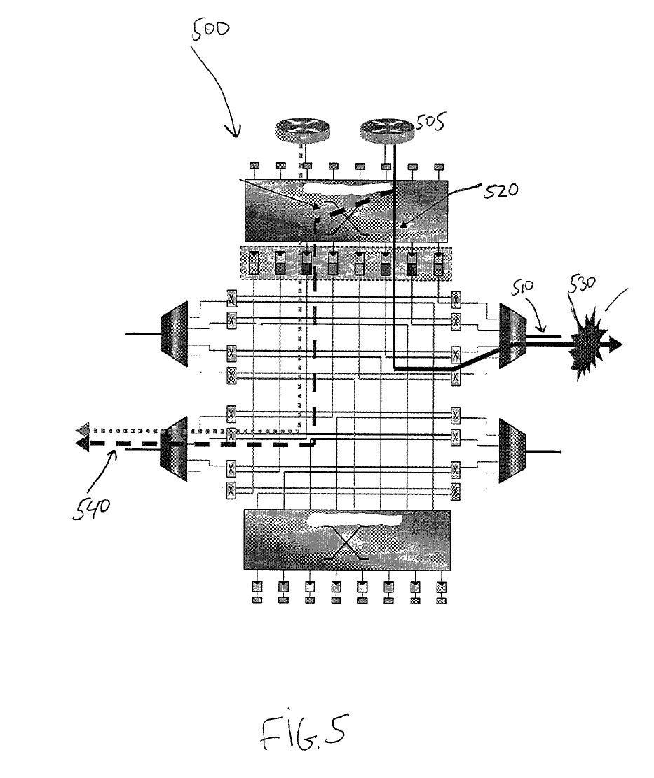

Fast protection switching is an important application of O-ADM rings. For example, in two fiber ring schemes, one fiber is typically used to carry data paths, while the other fiber is reserved for protection paths. A protection configuration for an embodiment of the invention is shown in FIG. 5, where numeral 520 denotes a working (primary) lightpath channel from router 505 on outbound fiber 510. When transmission through fiber 510 is interrupted by primary channel fault 530, reverse-direction protection path for this channel can be chosen from any available transmitter/receiver pair of multiplexer 500 and the destination node's multiplexer, e.g., dashed lightpath 540. Here, the transmit side switching fabric must perform switchover to the available channel. The O-ADM with wavelength switching fabric, therefore, achieves a measure of wavelength conversion between working and protection paths.

When the backup fiber is not needed for protection paths, it can carry lower-priority, pre-emptible traffic. The added wavelengths flexibility between working and protection paths thus improves resource utilization and increases operator revenues.

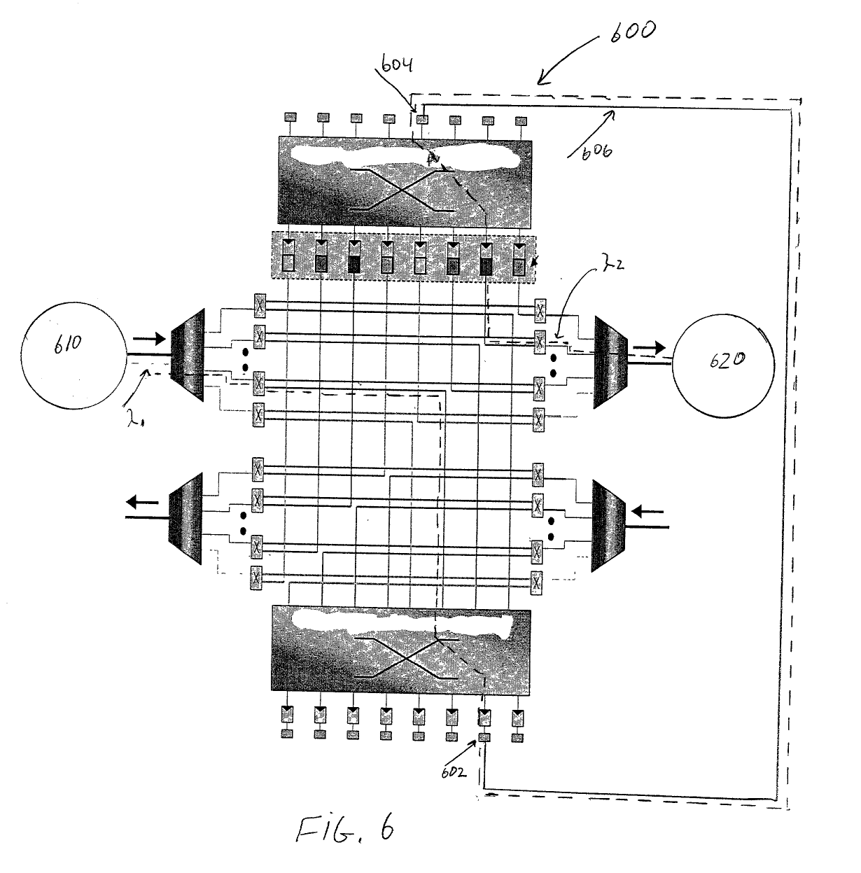

Note that the invention can also provide wavelength conversion when the multiplexer node is an intermediate node. This is illustrated in FIG. 6, where O-ADM 600 receives a data stream from node 610 on wavelength channel λ₁, routes it from receive side ITU-T interface 602 to transmit side ITU-T interface 604 over internal connection 606, and then routes it to node 620 over an available wavelength channel λ₂, which may differ from λ₁. Advantageously, the O-ADM that performs wavelength conversion also acts as a signal repeater because the signal is regenerated in the O-ADM for transmission on a different wavelength.

With regard to analog signal loss considerations, the 2×1 optical switches typically add approximately 0.5 dB each. Switch losses will, of course, be incurred in the more conventional O-ADM architecture shown in FIG. 1, too. The optical switching fabric losses may be higher, e.g., 3-6 dB, depending upon the size of the fabric. But switching fabric loss is incurred two times, at most, upon signal insertion and extraction, and not per span.

Although I have discussed multiplexers that are capable of both adding and dropping channels, the principles of the invention are equally applicable to multiplexers that can only add or drop channels, but not both. In such multiplexers, either some of the receive side components (receivers, optical switch fabric, receive side switches, receive side ITU-T interfaces), or some of the transmit side components (transponders, optical switch fabric, transmit side switches, transmit side ITU-T interfaces) need not be included.

It should be understood that the invention can find utility in applications other than DWDM systems with respect to which it has been described, and without regard to specific architectures addressed. Routing based on some physical characteristic of the signals is not limited to wavelength routing. Thus, the general principles can be extended mutatis mutandis to routing based on other physical characteristics, e.g., polarization or mode. And while certain aspects of the invention have been described in considerable detail with reference to specific embodiments thereof, other embodiments are possible. Some of the embodiments may not address all of the problems of existing multiplexers. Many modifications, changes, and variations are intended in the foregoing disclosure, and it will be appreciated by those of ordinary skill in the art that, in some instances, some features of the invention will be employed in the absence of a corresponding use of other features, without departure from the scope of the invention as set forth. The illustrative examples therefore do not define the metes and bounds of the invention, which function has been reserved for the following claims and their equivalents.

What is claimed is:

1. A multiplexer comprising:
a first switching fabric comprising a plurality of inputs and a plurality of outputs;
a plurality of transponders, one transponder of the plurality of transponders per output of the plurality of outputs of the first switching fabric, each transponder of the plurality of transponders comprising an input and an output, the input of said each transponder connected to the output of the first switching fabric associated with said each transponder;
a plurality of output switches, one output switch of the plurality of output switches per transponder of the plurality of transponders, each output switch of the plurality of output switches comprising a first input, a second input, and an output, the first input of said each output switch being coupled to the output of the transponder associated with said each output switch;
a link transmit interface comprising a plurality of inputs and an output, one input of the plurality of inputs of the link transmit interface per output switch of the plurality of output switches, each input of the plurality of inputs of the link transmit interface coupled to the output of the output switch associated with said each input of the link transmit interface, the output of the link transmit interface being capable of coupling channels appearing on the inputs of the link transmit interface to an optical transmission link; and
a link receive interface comprising an input and a plurality of outputs, one output of the plurality of outputs of the link receive interface per output switch of the plurality of output switches, each output of the plurality of outputs of the link receive interface coupled to the second input of the output switch associated with said each output of the link receive interface, the link receive interface being capable of coupling channels appearing on the input of the link receive interface to the outputs of the link receive interface.

2. A multiplexer according to claim 1, wherein the first switching fabric is a spatial switching fabric.

3. A multiplexer according to claim 1, wherein:
the first switching fabric is an optical spatial switching fabric capable of connecting any of the inputs of the plurality of inputs of the first switching fabric to any of the outputs of the plurality of outputs of the first switching fabric;
each of the transponders comprises a fixed wavelength laser;
the link receive interface is a dense wavelength division multiplexing fiber-optic interface coupling discrete wavelength channels appearing on the input of the link receive interface to the outputs of the link receive interface, one wavelength channel per output of the link receive interface; and
the link transmit interface is a dense wavelength division multiplexing interface.

4. A multiplexer according to claim 3, further comprising a computer coupled to the first switching fabric and the output switches for configuring the output switches to select which of the channels appearing on the input of the link receive interface are coupled to the optical transmission link, and for configuring the first switching fabric to select paths of signals appearing at the inputs of the first switching fabric through the first switching fabric.

5. A multiplexer comprising:
a first switching means comprising means for receiving a plurality of channels, a plurality of means for outputting channels, and means for routing channels from the means for receiving to the means for outputting;
a plurality of transponder means, one transponder means per means for outputting, each transponder means for receiving a channel from the means for outputting associated with said each transponder means, and for converting the channel received by said each transponder means into a fixed-wavelength channel;
a plurality of second switching means, one second switching means per transponder means, each second switching means comprising a first input, a second input, and an output, said each second switching means capable of switching the first or second input of said each second switching means to the output of said second switching means, the first input of said each second switching means coupled to the transponder means associated with said each second switching means so as to receive the converted fixed-wavelength channel of the transponder means associated we said each second switching means;
a link transmit interface for receiving channels appearing on the outputs of the second switching means and coupling the channels appearing on the outputs of the second switching means to a first dense wavelength multiplexed fiber-optic link; and
a link receive interface for receiving channels from a second dense wavelength division multiplexed fiber-optic link and coupling the channels received from the second fiber-optic link into second inputs of the plurality of second switching means, one channel received from the second fiber-optic link per second switching means.

6. A multiplexer according to claim 5, further comprising computer means coupled to the first switching means and the plurality of second switching means for configuring the plurality of second switching means to select which of the channels received from the second fiber-optic link are coupled to the first fiber-optic link, and for configuring the first switching means to select paths of channels appearing at the means for receiving of the first switching means through the first switching means.

7. A multiplexer comprising:
a first switching fabric comprising a plurality of inputs and a plurality of outputs;
a plurality of receivers, one receiver of the plurality of receivers per output of the plurality of outputs of the first switching fabric, each receiver of the plurality of receivers comprising an input coupled to the output of the first switching fabric associated with said each receiver;
a plurality of input switches, one input switch of the plurality of input switches per input of the plurality of inputs of the first switching fabric, each input switch of the plurality of input switches comprising an input, a first output, and a second output, the first output of said each input switch being coupled to the input of the first switching fabric associated with said each input switch;
a link receive interface comprising an input and a plurality of outputs, one output of the plurality of outputs of the link receive interface per input switch of the plurality of input switches, each output of the plurality of outputs of the link receive interface coupled to the input of the input switch associated with said each output of the link receive interface, the link receive interface being capable of coupling channels appearing on the input of the link receive interface to the outputs of the link receive interface; and
a link transmit interface comprising a plurality of inputs and an output, one input of the plurality of inputs of the link transmit interface per input switch of the plurality of input switches, each input of the plurality of inputs of the link transmit interface coupled to the second output of the input switch associated with said each input of the link transmit interface, the output of the link transmit interface being capable of coupling channels appearing on the plurality of inputs of the link transmit interface to an optical transmission link.

8. A multiplexer according to claim 7, wherein the first switching fabric is a spatial switching fabric.

9. A multiplexer according to claim 7, wherein:
the first switching fabric is an optical spatial switching fabric capable of connecting any of the inputs of the plurality of inputs of the first switching fabric to any of the outputs of the plurality of outputs of the first switching fabric;
the link receive interface is a dense wavelength division multiplexing fiber-optic interface coupling discrete wavelength channels appearing on the input of the link receive interface to the outputs of the link receive interface, one wavelength channel per output of the link receive interface; and
the link transmit interface is a dense wavelength division multiplexing interface.

10. A multiplexer according to claim 9, further comprising a computer coupled to the first switching fabric and the input switches for configuring the first switching fabric and the input switches to control paths of the discrete wavelength channels through the multiplexer.

11. A multiplexer comprising:
a first switching means comprising a plurality of means for receiving wavelength channels, a plurality of means for outputting wavelength channels, and means for routing channels from the means for receiving to the means for outputting;
a plurality of wavelength channel receivers for converting wavelength channels into electronic data flows, one receiver per means for outputting, each receiver coupled to the means for outputting associated with said each receiver;
a plurality of second switching means, one second switching means per means for receiving, each second switching means comprising an input, a first output, and a second output, said each second switching means being capable of switching the input of said each second switching means to the first or the second output of said each second switching means, the first output of said each second switching means coupled to the input of the first switching means associated with said each second switching means;
a link receive interface for receiving wavelength channels from a second dense wavelength division multiplexed fiber-optic link and coupling the wavelength channels received from the second fiber-optic link into the inputs of the second switching means, one wavelength channel received from the second fiber-optic link per second switching means;
a link transmit interface for receiving wavelength channels appearing on the second outputs of the second switching means and coupling the channels appearing on the second outputs of the second switching means into a first dense wavelength multiplexed fiber-optic link.

12. A multiplexer according to claim 11, further comprising a computer coupled to the first switching means and the plurality of second switching means for configuring the first switching means and the second switching means to control paths of the wavelength channels through the multiplexer.

13. A multiplexer comprising:
a first switching fabric comprising a plurality of inputs and a plurality of outputs;
a plurality of transponders, each transponder of the plurality of transponders comprising an input and an output, the input of said each transponder coupled to a different one of the outputs of the plurality of outputs of the first switching fabric;
a plurality of output switches, one output switch of the plurality of output switches per transponder of the plurality of transponders, each output switch of the plurality of output switches comprising a first input, a second input, and an output, the first input of said each output switch being coupled to the output of the transponder associated with said each output switch;
a link transmit interface comprising a plurality of inputs and an output, one input of the plurality of inputs of the link transmit interface per output switch of the plurality of output switches, each input of the plurality of inputs of the link transmit interface coupled to the output of the output switch associated with said each input of the link transmit interface, the output of the link transmit interface coupling channels appearing on the inputs of the link transmit interface to an optical transmission link;
a plurality of input switches, one input switch of the plurality of input switches per output switch of the plurality of output switches, each input switch of the plurality of input switches comprising an input, a first output, and a second output, the second output of said each input switch coupled to the second input of the output switch associated with said each input switch;
a link receive interface comprising an input and a plurality of outputs, one output of the plurality of outputs of the link receive interface per input switch of the plurality of input switches, each output of the plurality of outputs of the link receive interface coupled to the input of the input switch associated with said each output of the link receive interface, the link receive interface being capable of coupling channels appearing on the input of the link receive interface to the outputs of the link receive interface; and
a plurality of receivers, one receiver of the plurality of receivers per input switch of the plurality of input switches, each receiver of the plurality of receivers comprising an input, the input of said each receiver coupled to the first output of the input switch associated with said each receiver.

14. A multiplexer according to claim 13, wherein the first switching fabric is a spatial switching fabric.

15. A multiplexer according to claim 13, wherein:
the first switching fabric is an optical spatial switching fabric capable of connecting any of the inputs of the plurality of inputs of the first switching fabric to any of the outputs of the plurality of outputs of the first switching fabric;
each of the transponders of the plurality of transponders comprises a fixed wavelength laser;
the link receive interface is a dense wavelength division multiplexing fiber-optic interface coupling discrete wavelength channels appearing on the input of the link receive interface to the outputs of the link receive interface, one wavelength channel per output of the link receive interface; and
the link transmit interface is a dense wavelength division multiplexing interface.

16. A multiplexer according to claim 15, further comprising a computer coupled to the first switching fabric, the plurality of the input switches, and the plurality of the output switches for configuring the first switching fabric, the input switches, and the output switches to determine paths through the multiplexer of the discrete wavelength channels appearing on the input of the link receive interface and of signals at the inputs of the first switching fabric.

17. A multiplexer comprising:
a first switching means comprising means for receiving a plurality of channels, a plurality of means for outputting channels, and means for routing channels from the means for receiving to the means for outputting;
a plurality of transponders means, one transponder means per means for outputting, each transponder means for receiving a channel from the means for outputting and converting it into a fixed-wavelength channel;
a plurality of second switching means, one second switching means per transponder means, each second switching means comprising a first input, a second input, and an output, said each second switching means capable of switching the first or the second input of said each second switching means to the output of said each second switching means, the first input of said each second switching means being coupled to the transponder means associated with said each second switching means so as to receive the converted fixed-wavelength channel of the transponder means associated with said each second switching means;
a plurality of third switching means, one third switching means per second switching means, each third switching means comprising an input, a first output, and a second output, said each third switching means being capable of switching the input of said each third switching means to the first or the second output of said each third switching means, the second output of said each third switching means being coupled to the second input of the second switching means associated with the third switching means;
a plurality of wavelength channel receivers for converting wavelength channels into electronic data flows, one receiver per third switching means, each receiver coupled to the first output of the third switching means associated with said each receiver;
a link receive interface for receiving discrete wavelength channels from a second dense wavelength division multiplexed fiber-optic link and coupling the channels received from the second fiber-optic link into the inputs of the third switching means, one channel received from the second fiber-optic link per third switching means; and
a link transmit interface for receiving channels appearing on the outputs of the second switching means and coupling the channels appearing on the outputs of the second switching means to a first dense wavelength multiplexed fiber-optic link.

18. A multiplexer according to claim 17, further comprising computer means coupled to the first switching means, the plurality of the plurality of second switching means, and the plurality of the third switching means for configuring the first switching means, the second switching means, and the third switching means to determine paths through the multiplexer of the discrete wavelength channels appearing on the input of the link receive interface and of channels appearing at the means for receiving of the first switching means.

19. A multiplexer comprising:
a first switching fabric comprising a plurality of inputs and a plurality of outputs;
a plurality of receivers, one receiver of the plurality of receivers per output of the plurality of outputs of the first switching fabric, each receiver of the plurality of receivers comprising an input coupled to the output of the first switching fabric associated with said each receiver;
a plurality of input switches, one input switch of the plurality of input switches per input of the plurality of inputs of the first switching fabric, each input switch of the plurality of input switches comprising an input, a first output, and a second output, the first output of said each input switch being coupled to the input of the first switching fabric associated with said each input switch;
a link receive interface comprising an input and a plurality of outputs, one output of the plurality of outputs of the link receive interface per input switch of the plurality of input switches, each output of the plurality of outputs of the link receive interface coupled to the input of the input switch associated with said each output of the link receive interface, the link receive interface being capable of coupling channels appearing on the input of the link receive interface to the outputs of the link receive interface;
a plurality of output switches, one output switch of the plurality of output switches per input switch of the plurality of input switches, each output switch of the plurality of output switches comprising a first input, a second input, and an output, the second input of said each output switch being coupled to the second output of the input switch associated with said each output switch;
a link transmit interface comprising a plurality of inputs and an output, one input of the plurality of inputs of the link transmit interface per output switch of the plurality of output switches, each input of the plurality of inputs of the link transmit interface coupled to the output of the output switch associated with said each input of the link transmit interface, the output of the link transmit interface being capable of coupling channels appearing on the inputs of the link transmit interface to an optical transmission link.

20. A multiplexer according to claim 19, wherein the first switching fabric is a spatial switching fabric.

21. A multiplexer according to claim 19, wherein:
the first switching fabric is an optical spatial switching fabric capable of connecting any of the inputs of the plurality of inputs of the first switching fabric to any of the outputs of the plurality of outputs of the first switching fabric;
the link receive interface is a dense wavelength division multiplexing fiber-optic interface coupling discrete wavelength channels appearing on the input of the link receive interface to the outputs of the link receive interface, one wavelength channel per output of the link receive interface; and
the link transmit interface is a dense wavelength division multiplexing interface.

22. A multiplexer according to claim 21, further comprising a computer coupled to the first switching fabric, the input switches, and the output switches, the computer being for configuring the first switching fabric, the input switches, and the output switches to control paths of the discrete wavelength channels through the multiplexer.

23. A multiplexer comprising:
a first switching means comprising a plurality of means for receiving wavelength channels, a plurality of means for outputting channels, and means for routing channels from the means for receiving to the means for outputting;
a plurality of wavelength channel receivers for converting wavelength channels into electronic data flows, one receiver per means for outputting, each receiver coupled to the means for outputting associated with said each receiver;
a plurality of second switching means, one second switching means per means for receiving, each second switching means comprising an input, a first output, and a second output, said each second switching means being capable of switching the input of said each second switching means to the first or the second output of said each second switching means, the first output of said each second switching means coupled to the input of the first switching means associated with said each second switching means;
a link receive interface for receiving wavelength channels from a second dense wavelength division multiplexed fiber-optic link and coupling the wavelength channels received from the second fiber-optic link into the inputs of the second switching means, one wavelength channel received from the second fiber-optic link per second switching means;
a plurality of third switching means, one third switching means per second switching means, each third switching means comprising a first input, a second input, and an output, said each third switching means being capable of switching the first or the second input of said each third switching means to the output of said each third switching means, the second input of said each third switching means being coupled to the second output of the second switching means associated with said third switching means; and
a link transmit interface for receiving wavelength channels appearing on the outputs of the third switching means and coupling the channels appearing on the outputs of the third switching means into a first dense wavelength multiplexed fiber-optic link.

24. A multiplexer according to claim 23, further comprising a computer coupled to the first switching means, the plurality of second switching means, and the plurality of third switching means for configuring the first switching means, the second switching means, and the third switching means to control paths of the wavelength channels through the multiplexer.

25. A multiplexer comprising:
a first switching fabric comprising a plurality of inputs and a plurality of outputs;
a plurality of transponders, one transponder of the plurality of transponders per output of the plurality of outputs of the first switching fabric, each transponder of the plurality of transponders comprising an input and an output, the input of said each transponder coupled to the output of the first switching fabric associated with said each transponder;
a plurality of output switches, one output switch of the plurality of output switches per transponder of the plurality of transponders, each output switch of the plurality of output switches comprising a first input, a second input, and an output, the first input of said each output switch being coupled to the output of the transponder associated with said each output switch;
a link transmit interface comprising a plurality of inputs and an output, one input of the plurality of inputs of the link transmit interface per output switch of the plurality of output switches, each input of the plurality of inputs of the link transmit interface coupled to the output of the output switch associated with said each input of the link transmit interface, the link transmit interface being capable of coupling channels appearing on the inputs of the link transmit interface to the output of the link transmit interface;
a link receive interface comprising an input and a plurality of outputs, one output of the plurality of outputs of the link receive interface per output switch of the plurality of output switches, each output of the plurality of outputs of the link receive interface coupled to the second input of the output switch associated with said each output of the link receive interface, the link receive interface being capable of coupling channels appearing on the input of the link receive interface to the outputs of the link receive interface;
a multiplexer bypass connection comprising a channel input and a channel output;
a channel splitter coupled to an optical receive link, to the input of the link receive interface, and to the channel input of the multiplexer bypass connection, the channel splitter being capable of receiving a first plurality of channels and a second plurality of channels from the optical receive link, transmitting the first plurality of channels to the input of the link receive interface, and transmitting the second plurality of channels to the multiplexer bypass connection; and
a channel combiner coupled to an optical transmit link, to the output of the link transmit interface, and to the channel output of the multiplexer bypass connection, the channel combiner being capable of receiving the second plurality of channels from the output of the multiplexer bypass connection and the channels coupled to the output of the link transmit interface, and coupling the channels received by the channel combiner into the optical transmit link.

26. A multiplexer according to claim 25, wherein:
the first switching fabric is an optical spatial switching fabric capable of connecting any of the inputs of the plurality of inputs of the first switching fabric to any of the outputs of the plurality of outputs of the first switching fabric;
each of the transponders of the plurality of transponders comprises a fixed wavelength laser;
the link receive interface is a dense wavelength division multiplexing fiber-optic interface coupling discrete wavelength channels appearing on the input of the link receive interface to the outputs of the link receive interface, one wavelength channel per output of the link receive interface; and
the link transmit interface is a dense wavelength division multiplexing interface.

27. A multiplexer according to claim 26, further comprising a computer coupled to the first switching fabric and the output switches for configuring the output switches to select which of the channels appearing on the input of the link receive interface are coupled to the optical transmission link, and for configuring the first switching fabric to select paths of signals appearing at the inputs of the first switching fabric through the first switching fabric.

28. A multiplexer according to claim 27, wherein:
the channel splitter comprises a circulator; and
the channel combiner comprises a circulator.

29. A multiplexer according to claim 27, wherein the channel splitter comprises a wavelength filter for separating the first plurality of channels from the second plurality of channels.

30. A multiplexer comprising:
a first switching means comprising a plurality of means for receiving channels, a plurality of means for outputting channels, and means for routing channels from the means for receiving to the means for outputting;
a plurality of transponder means, one transponder means per means for outputting, each transponder means for receiving a channel from the means for outputting associated with said each transponder means and converting the channel received by said each transponder means into a fixed-wavelength channel;
a plurality of second switching means, one second switching means per transponder means, each second switching means comprising a first input, a second input, and an output, said each second switching means capable of switching the first or the second input of said each second switching means to the output of said each second switching means, the first input of said each second switching means coupled to the transponder means associated with said each second switching means so as to receive the converted fixed-wavelength channel of the transponder means associated we said each second switching means;
a link transmit interface means comprising an output, the link transmit interface means being for receiving channels appearing on the outputs of the second switching means and coupling the channels appearing on the outputs of the second switching means into the output of the link transmit interface means;
a link receive interface means comprising an input for receiving dense wavelength division multiplexed channels and coupling the received wavelength division multiplexed channels into the second inputs of the plurality of second switching means, one wavelength division multiplexed channel received by the link receive interface means per second switching means;
a multiplexer bypass connection comprising a channel input and a channel output;
a channel splitter means coupled to an optical receive link, to the input of the link receive interface means, and to the channel ,input of the multiplexer bypass connection, the channel splitter means being for receiving a first plurality of channels and a second plurality of channels from the optical receive link, transmitting the first plurality of channels to the link receive interface means, and transmitting the second plurality of channels to the multiplexer bypass connection; and
a channel combiner means coupled to an optical transmit link, to the output of the link transmit interface means, and to the channel output of the multiplexer bypass connection, the channel combiner being for receiving the second plurality of channels from the output of the multiplexer bypass connection and the channels coupled to the output of the link transmit interface means, and for coupling the channels received by the channel combiner means into the optical transmit link.

31. A multiplexer according to claim 30, further comprising computer means coupled to the first switching means and the plurality of second switching means for configuring the plurality of second switching means to select which of the channels at the inputs of the second switching means are coupled to the optical transmit link, and for configuring the first switching means to select paths of channels appearing at the means for receiving of the first switching means through the first switching means.

32. A multiplexer comprising:
a first switching fabric comprising a plurality of inputs and a plurality of outputs;
a plurality of receivers, one receiver of the plurality of receivers per output of the plurality of outputs of the first switching fabric, each receiver of the plurality of receivers comprising an input coupled to the output of the first switching fabric associated with said each receiver;
a plurality of input switches, one input switch of the plurality of input switches per input of the plurality of inputs of the first switching fabric, each input switch of the plurality of input switches comprising an input, a first output, and a second output, the first output of said each input switch being coupled to the input of the first switching fabric associated with said each input switch;
a link receive interface comprising an input and a plurality of outputs, one output of the plurality of outputs of the link receive interface per input switch of the plurality of input switches, each output of the plurality of outputs of the link receive interface coupled to the input of the input switch associated with said each output of the link receive interface, the link receive interface being capable of coupling channels appearing on the input of the link receive interface to the outputs of the link receive interface;
a link transmit interface comprising a plurality of inputs and an output, one input of the plurality of inputs of the link transmit interface per input switch of the plurality of input switches, each input of the plurality of inputs of the link transmit interface coupled to the second output of the input switch associated with said each input of the link transmit interface, the link transmit interface being capable of coupling channels appearing on the inputs of the link transmit interface to the output of the link transmit interface;
a multiplexer bypass connection comprising a channel input and a channel output;
a channel splitter coupled to an optical receive link, to the input of the link receive interface, and to the channel input of the multiplexer bypass connection, the channel splitter being capable of receiving a first plurality of channels and a second plurality of channels from the optical receive link, transmitting the first plurality of channels to the input of the link receive interface, and transmitting the second plurality of channels to the multiplexer bypass connection; and
a channel combiner coupled to an optical transmit link, to the output of the link transmit interface, and to the channel output of the multiplexer bypass connection, the channel combiner being capable of receiving the second plurality of channels from the output of the multiplexer bypass connection and the channels coupled to the output of the link transmit interface, and coupling the channels received by the channel combiner into the optical transmit link.

33. A multiplexer according to claim 32, wherein:
the first switching fabric is an optical spatial switching fabric capable of connecting any of the inputs of the plurality of inputs of the first switching fabric to any of the outputs of the plurality of outputs of the first switching fabric;
the link receive interface is a dense wavelength division multiplexing fiber-optic interface coupling discrete wavelength channels appearing on the input of the link receive interface to the outputs of the link receive interface, one wavelength channel per output of the link receive interface; and
the link transmit interface is a dense wavelength division multiplexing interface.

34. A multiplexer according to claim 33, further comprising a computer coupled to the first switching fabric and the input switches for configuring the first switching fabric and the input switches to control paths of the discrete wavelength channels through the multiplexer.

35. A multiplexer according to claim 34, wherein:
the channel splitter comprises a circulator; and
the channel combiner comprises a circulator.

36. A multiplexer according to claim 34, wherein the channel splitter comprises a wavelength filter for separating the first plurality of channels from the second plurality of channels.

37. A multiplexer comprising:
a first switching means comprising a plurality of means for receiving wavelength channels, a plurality of means for outputting wavelength channels, and means for routing wavelength channels from the means for receiving to the means for outputting;
a plurality of wavelength channel receivers for converting wavelength channels into electronic data flows, one receiver per means for outputting, each receiver coupled to the means for outputting associated with said each receiver;
a plurality of second switching means, one second switching means per means for receiving, each second switching means comprising an input, a first output, and a second output, said each second switching means capable of switching the input of said each second switching means to the first or the second output of said each second switching means, the first output of said each second switching means coupled to the input of the first switching means associated with said each second switching means;
a link receive interface means comprising an input, for receiving dense wavelength division multiplexed channels appearing at the input of the link receive interface means and coupling the received wavelength division multiplexed channels into the inputs of the second switching means, one received wavelength division multiplexed channel per second switching means;
a link transmit interface means comprising an output, the link transmit interface means being for receiving wavelength channels appearing on the second outputs of the second switching means and coupling the channels appearing on the second outputs of the second switching means into the output of the link transmit interface means;
a multiplexer bypass connection comprising a channel input and a channel output;
a channel splitter means coupled to an optical receive link, to the input of the link receive interface means, and to the channel input of the multiplexer bypass connection, the channel splitter means being for receiving a first plurality of wavelength channels and a second plurality of wavelength channels from the optical receive link, transmitting the first plurality of channels to the link receive interface means, and transmitting the second plurality of channels to the channel input of the multiplexer bypass connection; and
a channel combiner means coupled to an optical transmit link, to the output of the link transmit interface means, and to the channel output of the multiplexer bypass connection, the channel combiner being for receiving the second plurality of channels from the output of the multiplexer bypass connection and the channels coupled to the output of the link transmit interface means, and for coupling the channels received by the channel combiner means into the optical transmit link.

38. A multiplexer according to claim 37, further comprising computer means coupled to the first switching means and the plurality of second switching means for configuring the first switching means and the plurality of second switching means to control paths of the first plurality of wavelength channels through the multiplexer.

39. A multiplexer comprising:
a first switching fabric comprising a plurality of inputs and a plurality of outputs;
a plurality of transponders, each transponder of the plurality of transponders comprising an input and an output, the input of said each transponder connected to a different one of the outputs of the plurality of outputs of the first switching fabric;
a plurality of output switches comprising a first set of output switches and a second set of output switches, one output switch of the plurality of output switches per transponder of the plurality of transponders, each output switch of the plurality of output switches comprising a first input, a second input, and an output, the first input of said each output switch being coupled to the output of the transponder associated with said each output switch;
a first link transmit interface comprising a plurality of inputs and an output, one input of the plurality of inputs of the first link transmit interface per output switch of the first set of output switches, each input of the plurality of inputs of the first link transmit interface coupled to the output of the output switch associated with said each input of the first link transmit interface, the first link transmit interface being capable of coupling channels appearing on the inputs of the first link transmit interface to the output of the first link transmit interface;
a second link transmit interface comprising a plurality of inputs and an output, one input of the plurality of inputs of the second link transmit interface per output switch of the second set of output switches, each input of the plurality of inputs of the second link transmit interface coupled to the output of the output switch associated with said each input of the second link transmit interface, the second link transmit interface being capable of coupling channels appearing on the inputs of the second link transmit interface to the output of the second link transmit interface;
a plurality of input switches comprising a first set of input switches and a second set of input switches, one input switch of the first set of input switches per output switch of the first set of output switches, one input switch of the second set of input switches per output switch of the second set of output switches, each input switch of the plurality of input switches comprising an input, a first output, and a second output, the second output of said each input switch coupled to the second input of the output switch associated with said each input switch;
a first link receive interface comprising an input and a plurality of outputs, one output of the plurality of outputs of the first link receive interface per input switch of the first set of input switches, each output of the plurality of outputs of the first link receive interface coupled to the input of the input switch associated with said each output of the first link receive interface, the first link receive interface being capable of coupling channels appearing on the input of the first link receive interface to the outputs of the first link receive interface, one said channel appearing on the input of the first link receive interface per output of the plurality of outputs of the first link receive interface;
a second link receive interface comprising an input and a plurality of outputs, one output of the plurality of outputs of the second link receive interface per input switch of the second set of input switches, each output of the plurality of outputs of the second link receive interface coupled to the input of the input switch associated with said each output of the second link receive interface, the second link receive interface being capable of coupling channels appearing on the input of the second link receive interface to the outputs of the second link receive interface, one said channel appearing on the input of the second link receive interface per output of the plurality of outputs of the second link receive interface;
a second switching fabric comprising a plurality of inputs and a plurality of outputs, one input of the plurality of inputs of the second switching fabric per input switch of the plurality of input switches, each input of the plurality of inputs of the second switching fabric coupled to the first output of the input switch associated with said each input of the second switching fabric; and
a plurality of receivers, one receiver of the plurality of receivers per output of the plurality of outputs of the second switching fabric, each receiver of the plurality of receivers comprising an input, the input of said each receiver coupled to the output of the second switching fabric associated with said each receiver.

40. A multiplexer according to claim 39, wherein the first switching fabric and the second switching fabric are spatial switching fabrics.

41. A multiplexer according to claim 39, wherein:
the first switching fabric is an optical spatial switching fabric capable of connecting any of the inputs of the plurality of inputs of the first switching fabric to any of the outputs of the plurality of outputs of the first switching fabric;
the second switching fabric is an optical spatial switching fabric capable of connecting any of the inputs of the plurality of inputs of the second switching fabric to any of the outputs of the plurality of outputs of the second switching fabric;
each of the transponders of the plurality of transponders comprises a fixed wavelength laser;
the first link receive interface is a dense wavelength division multiplexing fiber-optic interface coupling discrete wavelength channels appearing on the input of the first link receive interface to the outputs of the first link receive interface;
the second link receive interface is a dense wavelength division multiplexing fiber-optic interface coupling discrete wavelength channels appearing on the input of the second link receive interface to the outputs of the second link receive interface;
the first and the second link transmit interfaces are dense wavelength division multiplexing interfaces.

42. A multiplexer according to claim 41, further comprising a computer coupled to the first switching fabric, the second switching fabric, the plurality of the input switches, and the plurality of the output switches for configuring the first switching fabric, the second switching fabric, the input switches, and the output switches to determine paths of the discrete wavelength channels appearing on the inputs of the first and second link receive interfaces and channels at the inputs of the first switching fabric through the multiplexer.

43. A multiplexer according to claim 42, further comprising:
a first multiplexer bypass connection comprising a channel input and a channel output;
a first channel splitter coupled to a first optical receive link, to the input of the first link receive interface, and to the channel input of the first multiplexer bypass connection, the first channel splitter capable of receiving a first plurality of channels and a second plurality of channels from the first optical receive link, transmitting the first plurality of channels to the input of the first link receive interface, and transmitting the second plurality of channels to the first multiplexer bypass connection;
a first channel combiner coupled to a first optical transmit link, to the output of the first link transmit interface, and to the channel output of the first multiplexer bypass connection, the first channel combiner capable of receiving the second plurality of channels from the channel output of the first multiplexer bypass connection and the channels coupled to the output of the first link transmit interface, and coupling the channels received by the first channel combiner into the first optical transmit link;
a second multiplexer bypass connection comprising a channel input and a channel output;
a second channel splitter coupled to a second optical receive link, to the input of the second link receive interface, and to the channel input of the second multiplexer bypass connection, the second channel splitter being capable of receiving a third plurality of channels and a fourth plurality of channels from the second optical receive link, transmitting the third plurality of channels to the input of the second link receive interface, and transmitting the fourth plurality of channels to the second multiplexer bypass connection; and
a second channel combiner coupled to a second optical transmit link, to the output of the second link transmit interface, and to the channel output of the second multiplexer bypass connection, the second channel combiner being capable of receiving the fourth plurality of channels from the channel output of the second multiplexer bypass connection and the channels coupled to the output of the second link transmit interface, and coupling the channels received by the second channel combiner into the second optical transmit link.

44. A method for restoring a communication path between a first input of the plurality of inputs of the first switching fabric of the multiplexer according to claim 42 and a second node, the multiplexer and the second node being connected in an optical network by a first optical fiber and a second optical fiber, wherein the first input of the multiplexer communicates with the second node through a first channel transmitted by the first link transmit interface and the first optical fiber, the method comprises:
detecting failure of a transmission path through the first optical fiber;
identifying a second channel available for communication between the multiplexer and the second node, the second node being capable of receiving the second channel, the second channel capable of being transmitted by the second link transmit interface through the second optical fiber;
configuring the first switching fabric to connect the first input of the first switching fabric associated with a first transponder of the plurality of transponders, the first transponder comprises a laser with a fixed wavelength associated with the second channel;
configuring the output switches to connect the output of the first transponder to the second link transmit interface; and
notifying the second node of switchover to the second channel.

45. A method for restoring a communication path between a first receiver of the plurality of receivers of the multiplexer according to claim 42 and a second node, the multiplexer and the second node being connected in an optical network by a first optical fiber and a second optical fiber, wherein the first receiver communicates with the second node through a first channel transmitted by the first optical fiber and the first link receive interface, the method comprises:
detecting failure of a transmission path through the first optical fiber;
identifying a second channel available for communication between the first receiver and the second node, the second node being capable of transmitting the second channel, the second channel capable of being received by the second link receive interface through the second optical fiber;
configuring the second switching fabric and the input switches to route the second channel to the first receiver; and
notifying the second node of switchover to the second channel.

46. A multiplexer comprising:
a first switching means comprising a plurality of means for receiving channels, a plurality of means for outputting channels, and a means for routing channels from the means for receiving of the first switching means to the means for outputting of the first switching means, the plurality of the means for receiving of the first switching means comprising a first subset of the means for receiving of the first switching means, the means for routing of the first switching means comprising means for routing each channel input through the first subset of the means for receiving of the first switching means to at least two of the means for outputting of the first switching means;
a plurality of transponder means, one transponder means per means for outputting of the first switching means, each transponder means for receiving a channel from the means for outputting of the first switching means associated with said each transponder means, and for converting the channel received by said each transponder means into a fixed-wavelength channel;
a plurality of output switching means comprising a first set of output switching means and a second set of output switching means, one output switching means per transponder means, each output switching means comprising a first input, a second input, and an output, said each output switching means capable of switching the first or the second input of said each output switching means to the output of said each output switching means, the first input of said each output switching means being coupled to the transponder means associated with said each output switching means for receiving the channel converted by said transponder means associated with said each output switching means;
a first link transmit interface for receiving channels appearing on the outputs of the first set of output switching means and coupling the channels appearing on the outputs of the first set of output switching means into a first dense wavelength division multiplexed fiber-optic link;
a second link transmit interface for receiving channels appearing on the outputs of the second set of output switching means and coupling the channels appearing on the outputs of the second set of output switching means into a second dense wavelength division multiplexed fiber-optic link;
a plurality of input switching means comprising a first set of input switching means and a second set of input switching means, one input switching means of the first set of input switching means per output switching means of the first set of output switching means, one input switching means of the second set of input switching means per output switching means of the second set of output switching means, each input switching means comprising an input, a first output, and a second output, said each input switching means capable of switching the input of said each input switching means to the first or the second output of said each input switching means, the second output of said each input switching means coupled to the second input of the output switching means associated with said each input switching means;
a first link receive interface for receiving discrete wavelength channels from a third dense wavelength division multiplexed fiber-optic link and for coupling the channels received from the third fiber-optic link into the inputs of the first set of input switching means, one channel received from the third fiber-optic link per input switching means of the first set of input switching means;
a second link receive interface for receiving discrete wavelength channels from a fourth dense wavelength division multiplexed fiber-optic link and for coupling the channels received from the fourth fiber-optic link into the inputs of the second set of input switching means, one channel received from the fourth fiber-optic link per input switching means of the second set of input switching means;
a second switching means comprising a plurality of means for receiving channels, a plurality of means for outputting channels, and a means for routing channels from the means for receiving of the second switching means to the means for outputting of the second switching means, the plurality of the means for receiving of the second switching means comprising a second subset of the means for receiving of the second switching means, the means for routing of the second switching means comprising means for routing each channel input through the second subset of the means for receiving of the second switching means to at least two of the means for outputting of the second switching means; and
a plurality of wavelength channel receivers for converting wavelength channels into electronic data flows, one receiver per means for outputting of the second switching means, each wavelength channel receiver coupled to the means for outputting of the second switching means associated with said each receiver.

47. A multiplexer according to claim 46, further comprising computer means coupled to the first switching means, the second switching means, the plurality of input switching means, and the plurality of output switching means, the computer means being for configuring the first switching means, the second switching means, the plurality of the input switching means, and the plurality of output switching means to control paths through the multiplexer of the channels received from the third and fourth fiber-optic links and of channels received by the means for receiving of the first switching means.

48. A multiplexer comprising:
a first switching fabric comprising a plurality of inputs and a plurality of outputs;
a plurality of transponders, each transponder of the plurality of transponders comprising an input and an output, the input of said each transponder connected to a different one of the outputs of the plurality of outputs of the first switching fabric;
a plurality of output switches, one output switch of the plurality of output switches per transponder of the plurality of transponders, each output switch of the plurality of output switches comprising a first input, a second input, and an output, the first input of said each output switch being coupled to the output of the transponder associated with said each output switch;
a link transmit interface comprising a plurality of inputs and an output, one input of the plurality of inputs of the link transmit interface per output switch of the plurality of output switches, each input of the plurality of inputs of the link transmit interface coupled to the output of the output switch associated with said each input of the link transmit interface, the output of the link transmit interface coupling channels appearing on the inputs of the link transmit interface to the output of the link transmit interface;
a plurality of input switches, one input switch of the plurality of input switches per output switch of the plurality of output switches, each input switch of the plurality of input switches comprising an input, a first output, and a second output, the second output of said each input switch coupled to the second input of the output switch associated with said each input switch;
a link receive interface comprising an input and a plurality of outputs, one output of the plurality of outputs of the link receive interface per input switch of the plurality of input switches, each output of the plurality of outputs of the link receive interface coupled to the input of the input switch associated with said each output of the link receive interface, the link receive interface being capable of coupling channels appearing on the input of the link receive interface to the outputs of the link receive interface, one said channel appearing on the input of the link receive interface per output of the plurality of outputs of the link receive interface;
a second switching fabric comprising a plurality of inputs and a plurality of outputs, one input of the plurality of inputs of the second switching fabric per input switch of the plurality of input switches, each input of the plurality of inputs of the second switching fabric coupled to the first output of the input switch associated with said each input of the second switching fabric; and
a plurality of receivers, one receiver of the plurality of receivers per output of the plurality of outputs of the second switching fabric, each receiver of the plurality of receivers comprising an input, the input of said each receiver coupled to the output of the second switching fabric associated with said each receiver.

49. A multiplexer according to claim 48, wherein the first switching fabric and the second switching fabric are spatial switching fabrics.

50. A multiplexer according to claim 48, wherein:
the first switching fabric is an optical spatial switching fabric capable of connecting any of the inputs of the plurality of inputs of the first switching fabric to any of the outputs of the plurality of outputs of the first switching fabric;
the second switching fabric is an optical spatial switching fabric capable of connecting any of the inputs of the plurality of inputs of the second switching fabric to any of the outputs of the plurality of outputs of the second switching fabric;
each of the transponders of the plurality of transponders comprises a fixed wavelength laser;
the link receive interface is a dense wavelength division multiplexing fiber-optic interface;
the link transmit interface is a dense wavelength division multiplexing interface.

51. A multiplexer according to claim 50, further comprising a computer coupled to the first switching fabric, the second switching fabric, the plurality of the input switches, and the plurality of the output switches for configuring the first switching fabric, the second switching fabric, the input switches, and the output switches to determine paths through the multiplexer of the channels appearing on the input of the link receive interface and channels at the inputs of the first switching fabric.

52. A multiplexer comprising:
a first switching means comprising a plurality of means for receiving channels, a plurality of means for outputting channels, and a means for routing channels from the means for receiving of the first switching means to the means for outputting of the first switching means, the plurality of the means for receiving of the first switching means comprising a first subset of the means for receiving of the first switching means, the means for routing of the first switching means comprising means for routing each channel input through the first subset of the means for receiving of the first switching means to at least two of the means for outputting of the first switching means;
a plurality of transponder means, one transponder means per means for outputting of the first switching means, each transponder means for receiving a channel from the means for outputting of the first switching means associated with said each transponder means, and for converting the channel received by said each transponder means into a fixed-wavelength channel;
a plurality of output switching means, one output switching means per transponder means, each output switching means comprising a first input, a second input, and an output, said each output switching means being for switching channels between the first or the second input of said each output switching means and the output of said each output switching means, the first input of said each output switching means being coupled to the transponder means associated with said each output switching means for receiving the channel converted by said transponder means associated with said each output switching means;
a link transmit interface for receiving channels appearing on the outputs of the output switching means and coupling the channels appearing on the outputs of the output switching means into a first dense wavelength division multiplexed fiber-optic link;
a plurality of input switching means, one input switching means per output switching means, each input switching means comprising an input, a first output, and a second output, said each input switching means being for switching channels between the input of said each input switching means and the first and the second outputs of said each input switching means, the second output of said each input switching means coupled to the second input of the output switching means associated with said each input switching means;
a link receive interface for receiving discrete wavelength channels from a second dense wavelength division multiplexed fiber-optic link and for coupling the channels received from the second fiber-optic link into the inputs of the input switching means, one channel received from the second fiber-optic link per input switching means;
a second switching means comprising a plurality of means for receiving channels, a plurality of means for outputting channels, and a means for routing channels from the means for receiving of the second switching means to the means for outputting of the second switching means, the plurality of the means for receiving of the second switching means comprising a second subset of the means for receiving of the second switching means, the means for routing of the second switching means comprising means for routing each channel input through the second subset of the means for receiving of the second switching means to at least two of the means for outputting of the second switching means; and
a plurality of wavelength channel receivers for converting wavelength channels into electronic data flows, one receiver per means for outputting of the second switching means, each wavelength channel receiver coupled to the means for outputting of the second switching means associated with said each receiver.

53. A multiplexer according to claim 52, further comprising computer means coupled to the first switching means, the second switching means, the plurality of input switching means, and the plurality of output switching means, the computer means being for configuring the first switching means, the second switching means, the plurality of the input switching means, and the plurality of output switching means to control paths through the multiplexer of the channels received from the second fiber-optic link and of channels received by the means for receiving of the first switching means.
